(19) United States
(12) Patent Application Publication
(10) Pub. No.: US 2011/0013055 A1
(43) Pub. Date: Jan. 20, 2011

(54) Optical sensor and semiconductor device

(75) Inventors: Sang-Chul Sul, Suwon-si (KR); Myung-Bok Lee, Suwon-si (KR); Hoon-Sang Oh, Seongnam-si (KR); Young-Gu Jin, Hwaseiong-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/801,938

(22) Filed: Jul. 2, 2010

(30) Foreign Application Priority Data
Jul. 16, 2009 (KR) 10-2009-0064914

(51) Int. Cl. H04N 5/335

(52) U.S. Cl. 348/273; 348/E05.091

(57) ABSTRACT

Example embodiments are directed to a semiconductor device including a color pixel array on a substrate; a distance pixel array on the substrate; a light-inducing member on the color pixel array and the distance pixel array; an infrared light cut filter on the light-inducing member and configured to block infrared light; a near infrared light filter on the light-inducing member and configured to allow near infrared light to pass; and an RGB filter on the light-inducing member and configured to allow visible light to pass. According to example embodiments, a method of manufacturing a semiconductor device may include forming a color pixel array on a substrate; forming a distance pixel array on the substrate; forming a light-inducing member on the color pixel array and the distance pixel array; forming an infrared light cut filter on the light-inducing member; forming a near infrared light filter on the light-inducing member; forming a RGB filter on the light-inducing member; and forming a plurality of lenses on the infrared light cut filter and the near infrared light filter.

### CROSS-REFERENCE TO RELATED APPLICATION

This application claims priority under 35 U.S.C. § 119 to Korean Patent Application No. 2009-0064914, filed on Jul. 16, 2009 in the Korean Intellectual Property Office (KIPO), the contents of which are herein incorporated by reference in their entirety.

### BACKGROUND

1. Field

Example embodiments relate to a semiconductor device including an optical filter of a three-dimensional image sensor and a method of manufacturing the same. More particularly, example embodiments relate to a semiconductor device having an optical filter of a three-dimensional image sensor that may provide image information and distance information, and a method of manufacturing the semiconductor device.

2. Description

A conventional CMOS image sensor may provide only an image. The conventional CMOS image sensor is shown in FIG. 1.

Referring to FIG. 1, the CMOS image sensor may include an active color filter pixel array region 20 and a CMOS control circuit 30. The active color filter pixel array region 20 may include a plurality of unit pixels 22 arranged in a matrix.

The CMOS control circuit 30 may be arranged around/besides the active color pixel array region 20. The CMOS control circuit 30 may include a plurality of CMOS transistors. The CMOS control circuit 30 may provide the unit pixels 22 of the active color pixel array region 20 with signals. Further, the CMOS control circuit 30 may control the signals.

The unit pixel 22 may include a photo diode, a transfer transistor, a reset transistor, a drive transistor, and/or a selection transistor. The photo diode may receive light to generate photocharges. The transfer transistor may transfer the photocharges to a floating diffusion region. The reset transistor may periodically reset the photocharges in the floating diffusion region. The drive transistor may function as a source follower buffer amplifier. The drive transistor may buffer signals in accordance with the photocharges in the floating diffusion region. The selection transistor may function as a switch for selecting the pixels 22.

FIG. 2A is an example cross-sectional view illustrating the photodiode of the unit pixel 22, and FIG. 2B is a graph showing a light spectrum of the unit pixel 22.

Referring to FIG. 2A, a photodiode layer 40 may be formed on a semiconductor substrate. A color filter 45 and a lens 50 may be sequentially formed on the photodiode layer 40.

A filter 60 may be arranged over the lens 50. The filter 60 may allow visible light to pass. In contrast, the filter 60 may block ultraviolet light.

The conventional color image sensor may provide only the image information. However, the conventional color image sensor may not provide distance information.

### SUMMARY

According to example embodiments, a semiconductor device may include a color pixel array on a substrate, a distance pixel array on the substrate, a light-inducing member on the color pixel array and the distance pixel array, an infrared light cut filter on the light-inducing member and configured to block infrared light, a near infrared light filter on the light-inducing member and configured to allow near infrared light to pass through, and an RGB filter on the light-inducing member and configured to allow a visible light to pass.

According to example embodiments, the infrared light cut filter is on the color pixel array.

According to example embodiments, the near infrared light filter on the distance pixel array.

According to example embodiments, the RGB filter is on the infrared light cut filter.

According to example embodiments, the infrared light cut filter on the RGB filter.

According to example embodiments, the visible light may have a wavelength of about 400 nm to about 700 nm.

According to example embodiments, the semiconductor device may further include a plurality of lenses on the infrared light cut filter and the near infrared light filter.

According to example embodiments, the infrared light cut filter and the near infrared light filter may include a silicon oxide layer and a titanium oxide layer sequentially stacked, the silicon oxide layer and the titanium oxide layer having different thicknesses.

According to example embodiments, the RGB filter and the near infrared light filter may include a pigment or a dye.

According to example embodiments, an optical sensor may include a color pixel array on a substrate, a distance pixel array on the substrate and a RGB filter on the color pixel array and configured to allow visible light to pass.

According to example embodiments, the optical sensor may further include a near infrared light filter on the distance array and configured to allow near infrared light to pass; and a stack type filter on the RGB filter and configured to allow visible light to pass.

According to example embodiments, the optical sensor may further include an infrared light cut filter on the color pixel array and configured to allow visible light to pass; and a long wave pass filter on the distance pixel array and configured to allow infrared light to pass.

According to example embodiments, a communication device may include a camera lens module; a three-dimensional optical system including the optical sensor; and a display unit.

According to example embodiments, a system may include a three-dimensional optical system, wherein the optical system includes the optical sensor and is configured to provide distance and image information.

According to example embodiments, a method of manufacturing a semiconductor device may include forming a color pixel array on a substrate, forming a distance pixel array on the substrate, forming a light-inducing member on the color pixel array and the distance pixel array, forming an infrared light cut filter on the light-inducing member, forming a near infrared light filter on the light-inducing member, forming a RGB filter on the light-inducing member, and forming a plurality of lenses on the infrared light cut filter and the near infrared light filter.

According to example embodiments, the method may further include forming the infrared light cut filter on the color pixel array and forming the near infrared light filter on the distance array.

According to example embodiments, the method may further include forming the infrared light cut filter on the RGB filter.

According to example embodiments, the method may further include forming the RGB filter on the infrared light cut filter.

According to example embodiments, forming the infrared light cut filter and the near infrared light filter may include forming a structure of sequentially stacked layers of silicon oxide and titanium oxide, the silicon oxide layer and the titanium oxide layer having different thicknesses.

According to example embodiments, forming the near infrared light filter may include forming a multi-layered structure including at least two inorganic materials that have different reflectivities.

According to example embodiments, the method may further include forming a planarization layer on the light-inducing member.

According to example embodiments, the light-inducing member may include a resin layer.

### BRIEF DESCRIPTION OF THE DRAWINGS

The above and other features and advantages will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a circuit diagram illustrating a conventional CMOS image sensor;

FIG. 2A is a cross-sectional view illustrating a photodiode of a unit pixel in FIG. 1

FIG. 2B is a graph showing a light spectrum of the unit pixel in FIG. 1.

FIG. 3 is a cross-sectional view of an optical sensor including an RGB-Z chip, an RGB filter and a stack type single band filter according to example embodiments;

FIG. 4 is a graph showing transmittance of the stack type single band filter in FIG. 3, according to example embodiments;

FIG. 5 is a cross-sectional view illustrating the stack type single band filter of FIG. 4, according to example embodiments;

FIG. 6 is a graph showing transmittance of a stack type single band filter according to example embodiments;

FIG. 7 is a cross-sectional view illustrating the stack type single band filter of FIG. 6, according to example embodiments;

FIG. 8 is a graph showing transmittance of a stack type single band filter according to example embodiments;

FIG. 9 is a cross-sectional view illustrating the filter with the transmittance of FIG. 8, according to example embodiments;

FIG. 10 is a cross-sectional view of an optical sensor, according to example embodiments;

FIG. 11 is a plan view illustrating of the optical sensor including an RGB-Z chip, according to example embodiments;

FIG. 12 is a cross-sectional view of a semiconductor device including an optical sensor of FIG. 11, according to example embodiments;

FIG. 13 is a cross-sectional view of a semiconductor device including an optical sensor of FIG. 11, according to example embodiments;

FIG. 14 is a front view of a cellular phone including the optical sensor; and

FIG. 15 is a block diagram illustrating a system including the optical sensor.

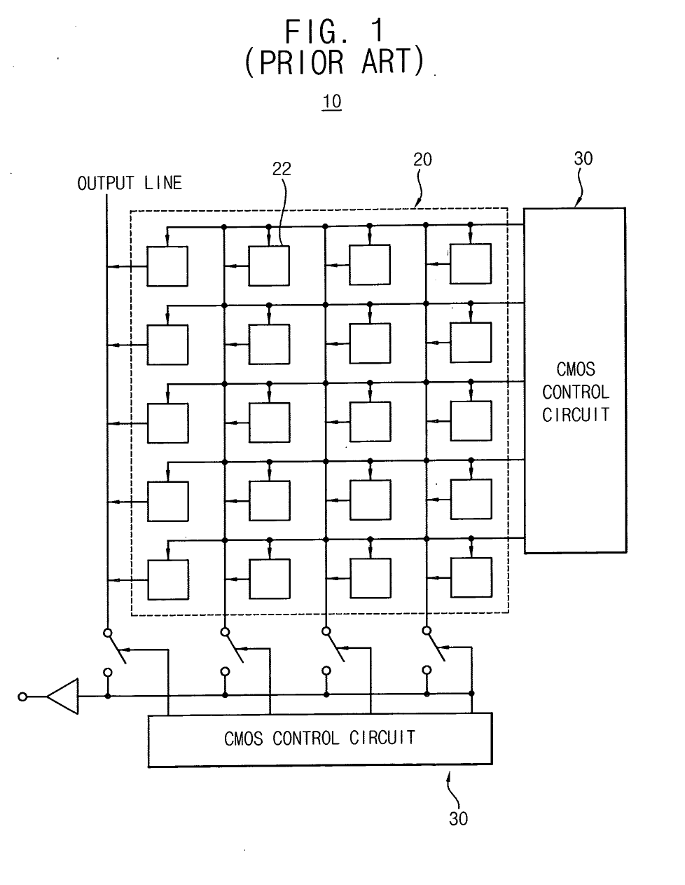

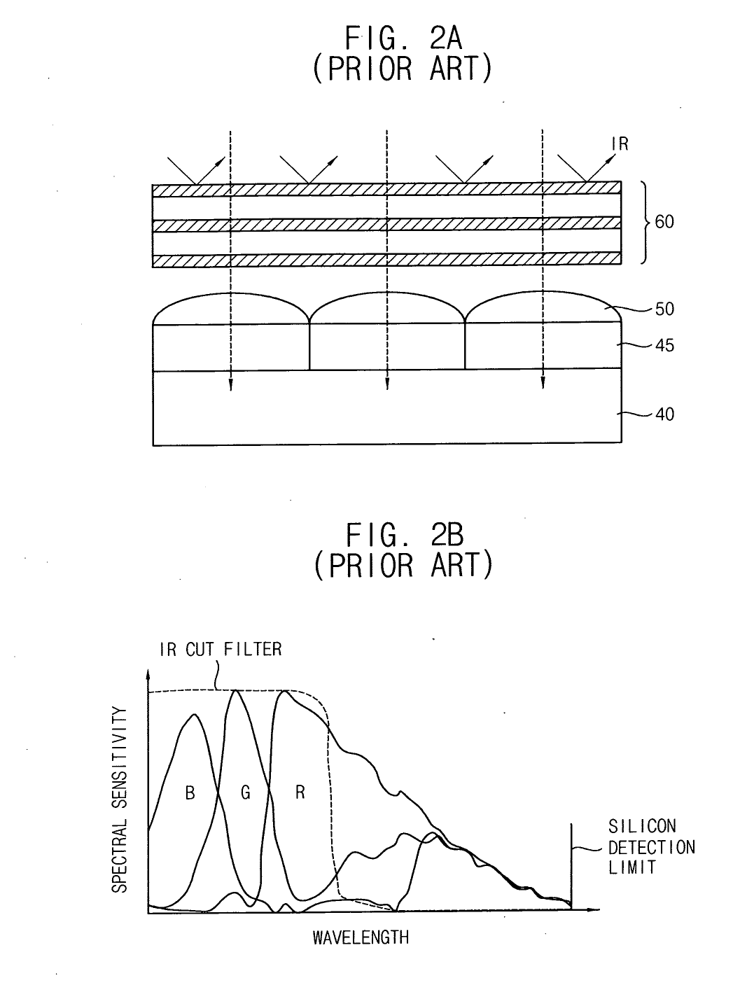

### DETAILED DESCRIPTION OF EXAMPLE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/ acts involved.

Hereinafter, example embodiments will be explained in detail with reference to the accompanying drawings.

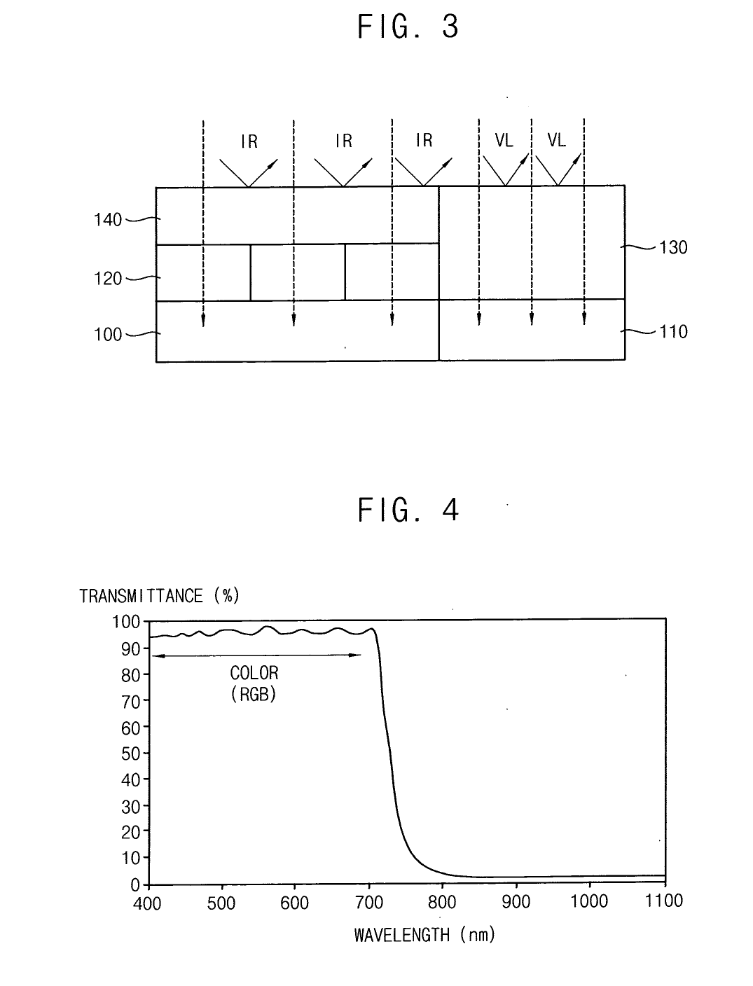

FIG. 3 is a cross-sectional view of an optical sensor including an RGB-Z chip, an RGB filter and a stack type single band filter according to example embodiments;

Referring to FIG. 3, the RGB-Z chip may include a semiconductor substrate having a color pixel array photodiode region 100 and a distance pixel array region 110. An RGB filter 120 may be formed on the color pixel array photodiode region 100. The RGB filter 120 may allow visible light to pass through it. In contrast, the RGB filter 120 may block near infrared light. In example embodiments, the RGB filter 120 may include polymer. A near infrared light filter 130 may be formed on the distance pixel array region 110. The near infrared light filter 130 may block the visible light. In contrast, the near infrared light filter 130 may allow the infrared light to pass through it. In example embodiments, the near infrared light filter 130 may include polymer.

In example embodiments, the RGB filter 120 and the near infrared light filter 130 may include other materials such as a dye capable of selectively blocking a light.

The stack type single band filter 140 may be arranged on the RGB filter 120. The stack type single band filter 140 may allow visible light to pass through. In contrast, the stack type single band filter 140 may block the infrared light. In example embodiments, the stack type single band filter 140 may include silicon oxide and titanium oxide formed by a chemical vapor deposition (CVD) process, an atomic layer deposition (ALD) process, or the like.

Light may be incident on a lens module. The stack type single band filter 140 may allow the visible light to pass through. In contrast, the stack type single band filter 140 may block the infrared light. The visible light may be incident to the RGB filter 120. The RGB filter 120 may allow the visible light to pass through. Thus, only the visible light may be incident to the color pixel array photodiode region 100.

Further, light may be incident to the near infrared light filter 130. The near infrared light filter 130 may allow the infrared light to pass through. In contrast, the near infrared light 130 may block the visible light. Thus, only the infrared light may be incident to the distance pixel region 110.

According to example embodiments, the RGB-Z chip may include the color pixel array and/or the distance pixel array. Thus, the optical sensor may provide the image information and/or the distance information.

FIG. 4 is a graph showing transmittance of a stack type single band filter according to example embodiments.

Referring to FIG. 4, the stack type single band filter may allow visible light having a wavelength of about 400 nm to about 700 nm to pass. In contrast, the stack type single band filter may block a near infrared light having a wavelength of about 830 nm to about 870 nm and a wavelength of no less than about 900 nm.

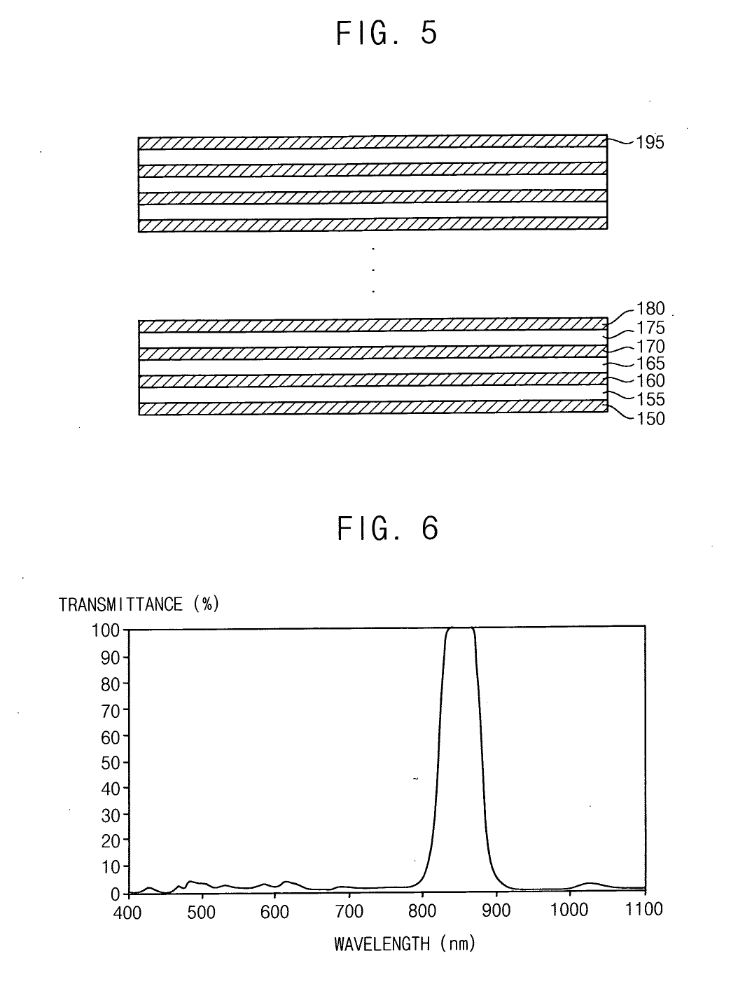

FIG. 5 is a cross-sectional view illustrating the stack type single band filter in FIG. 4 according to example embodiments.

TABLE 1

| Layer | Material | Thickness(nm) |
|---|---|---|
| 1 | SiO2 | 85 |
| 2 | TiO2 | 25 |
| 3 | SiO2 | 5 |
| 4 | TiO2 | 75 |
| 5 | SiO2 | 20 |
| 6 | TiO2 | 10 |
| 7 | SiO2 | 160 |
| 8 | TiO2 | 15 |
| 9 | SiO2 | 10 |
| 10 | TiO2 | 75 |
| 11 | SiO2 | 10 |
| 12 | TiO2 | 20 |
| 13 | SiO2 | 175 |
| 14 | TiO2 | 15 |
| 15 | SiO2 | 10 |
| 16 | TiO2 | 100 |
| 17 | SiO2 | 180 |
| 18 | TiO2 | 110 |
| 19 | SiO2 | 180 |
| 20 | TiO2 | 110 |
| 21 | SiO2 | 180 |
| 22 | TiO2 | 110 |
| 23 | SiO2 | 170 |
| 24 | TiO2 | 20 |
| 25 | SiO2 | 15 |
| 26 | TiO2 | 80 |
| 27 | SiO2 | 10 |
| 28 | TiO2 | 20 |
| 29 | SiO2 | 175 |
| 30 | TiO2 | 20 |
| 31 | SiO2 | 20 |
| 32 | TiO2 | 60 |
| 33 | SiO2 | 15 |
| 34 | TiO2 | 20 |

Referring to FIG. 5, a first layer 150 may include a silicon oxide layer having a thickness of about 85 nm. A second layer 155 may include a titanium oxide layer having a thickness of about 25 nm. A third layer 160 may include a silicon oxide layer having a thickness of about 5 nm. A fourth layer 165 may include a titanium oxide layer having a thickness of about 75 nm. A fifth layer 170 may include a silicon oxide layer having a thickness of about 20 nm. A sixth layer 175 may include a titanium oxide layer having a thickness of about 10 nm. A seventh layer 180 may include a silicon oxide layer having a thickness of about 160 nm. A thirty-fourth layer 195 may include a silicon oxide layer having a thickness of about 20 nm.

In example embodiments, the optical sensor may be formed by a CVD process, an ALD process, or the like, using silicon oxide and titanium oxide in a single chamber.

The stack type single band filter including the silicon oxide layer and the titanium oxide layer sequentially stacked may allow light having the wavelength of about 400 nm to about 700 nm to pass. In contrast, the stack type single band filter may block the light having a wavelength of no less than about 700 nm.

The transmittance of the light through the stack type single band filter may be determined in accordance with reflectivities, extinction coefficients, thickness differences, or the like.

FIG. 6 is a graph showing transmittance of a stack type single band filter according to example embodiments.

Referring to FIG. 6, the stack type single band filter may block a light having a wavelength of no more than about 800 nm and a light having a wavelength of no less than about 900 nm. In contrast, the stack type single band filter may allow light having a wavelength of about 800 nm to about 900 nm to pass through.

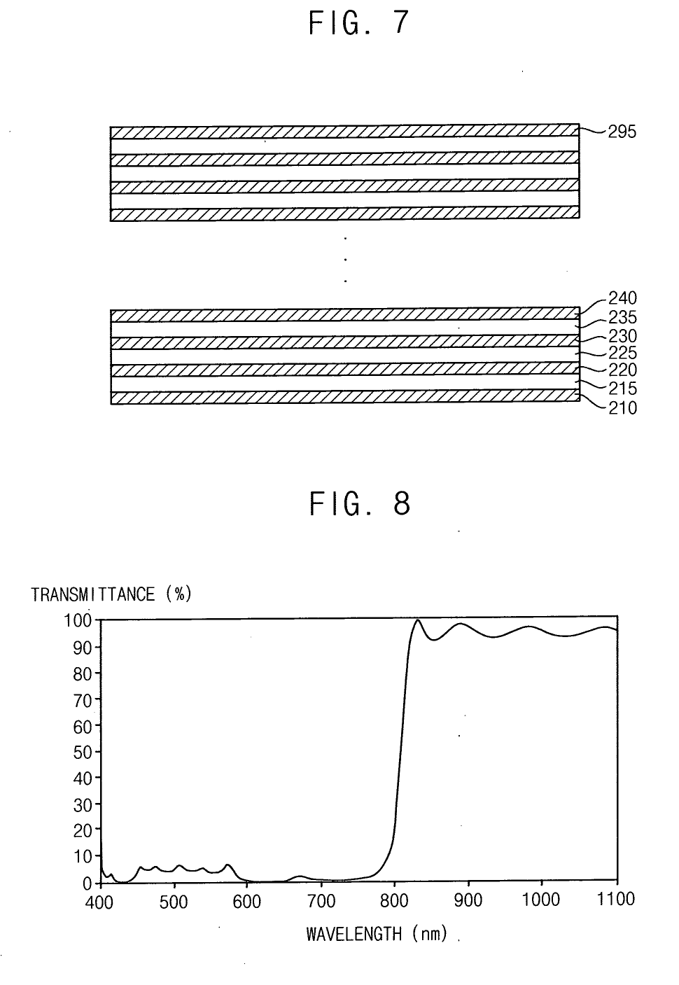

FIG. 7 is a cross-sectional view illustrating the stack type single band filter in FIG. 6, according to example embodiments.

TABLE 2

| Layer | Material | Thickness(nm) |
|---|---|---|
| 1 | SiO2 | 85 |
| 2 | TiO2 | 25 |
| 3 | SiO2 | 5 |
| 4 | TiO2 | 75 |
| 5 | SiO2 | 20 |
| 6 | TiO2 | 10 |
| 7 | SiO2 | 160 |
| 8 | TiO2 | 15 |
| 9 | SiO2 | 10 |
| 10 | TiO2 | 75 |
| 11 | SiO2 | 10 |
| 12 | TiO2 | 20 |
| 13 | SiO2 | 175 |
| 14 | TiO2 | 15 |
| 15 | SiO2 | 10 |
| 16 | TiO2 | 100 |
| 17 | SiO2 | 180 |
| 18 | TiO2 | 110 |
| 19 | SiO2 | 180 |
| 20 | TiO2 | 110 |
| 21 | SiO2 | 180 |
| 22 | TiO2 | 110 |
| 23 | SiO2 | 170 |
| 24 | TiO2 | 20 |
| 25 | SiO2 | 15 |
| 26 | TiO2 | 80 |
| 27 | SiO2 | 10 |
| 28 | TiO2 | 20 |
| 29 | SiO2 | 175 |
| 30 | TiO2 | 20 |
| 31 | SiO2 | 25 |
| 32 | TiO2 | 60 |
| 33 | SiO2 | 15 |
| 34 | TiO2 | 20 |

Referring to FIG. 7, a first layer 210 may include a silicon oxide layer having a thickness of about 85 nm. A second layer 215 may include a titanium oxide layer having a thickness of about 25 nm. A third layer 220 may include a silicon oxide layer having a thickness of about 5 nm. A fourth layer 225 may include a titanium oxide layer having a thickness of about 75 nm. A fifth layer 230 may include a silicon oxide layer having a thickness of about 20 nm. A sixth layer 235 may include a titanium oxide layer having a thickness of about 10 nm. A seventh layer 240 may include a silicon oxide layer having a thickness of about 160 nm. A thirty-fourth layer 295 may include a titanium oxide layer having a thickness of about 20 nm.

In example embodiments, the optical sensor may be formed by a CVD process, an ALD process, or the like, using silicon oxide and titanium oxide in a single chamber.

The stack type single band filter including the silicon oxide layer and the titanium oxide layer sequentially stacked may allow light having the wavelength of about 800 nm to about 900 nm to pass through.

The transmittance of light through the stack type single band filter may be determined in accordance with reflectivities, extinction coefficients, thickness differences, or the like.

FIG. 8 is a graph showing transmittance of a stack type single band filter according to example embodiments.

Referring to FIG. 8, the stack type single band filter may allow an infrared light having a wavelength of no less than about 800 nm to pass through. In contrast, the stack type single band filter may block infrared light having a wavelength of no greater than about 800 nm.

Thus, an infrared light having a desired wavelength may be obtained using the stack type single band filter. For example, the stack type single band filter may be used in a distance detection system using infrared data.

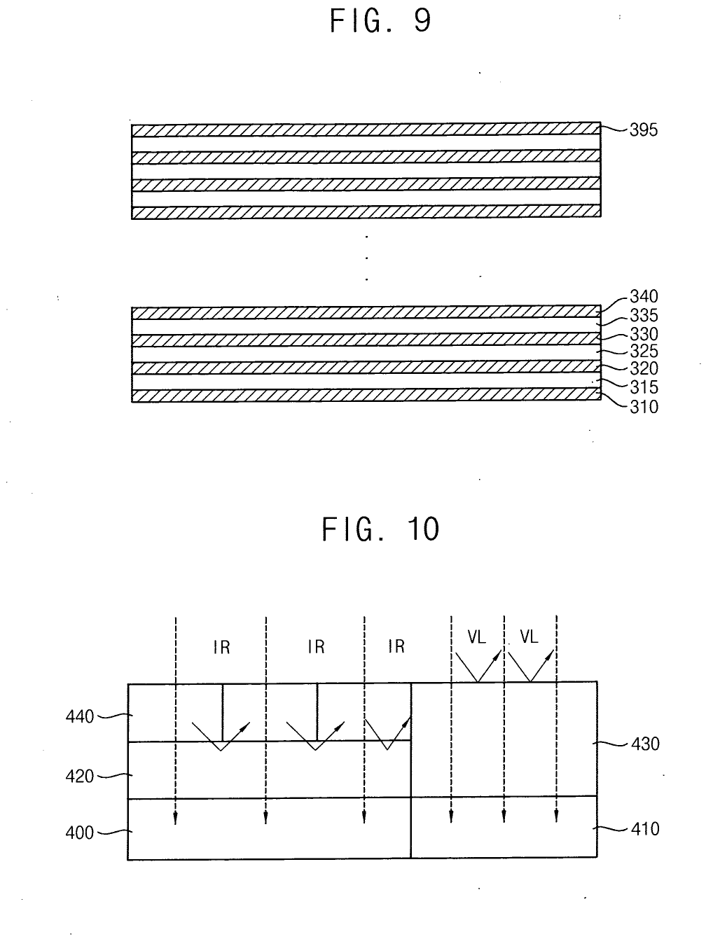

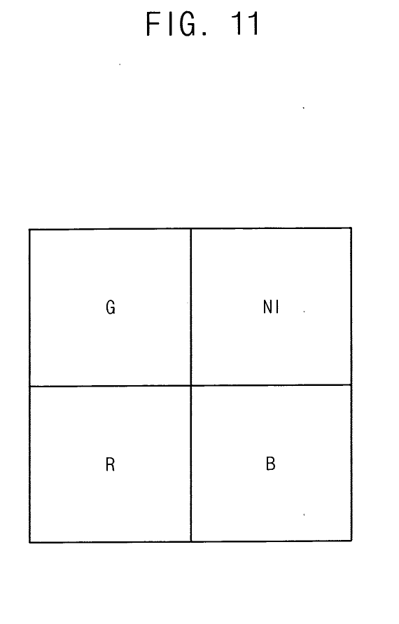

FIG. 9 is a cross-sectional view illustrating the filter having the transmittance of FIG. 8, according to example embodiments.

TABLE 3

| Layer | Material | Thickness(nm) |
|---|---|---|
| 1 | TiO2 | 35 |
| 2 | SiO2 | 85 |
| 3 | TiO2 | 50 |
| 4 | SiO2 | 70 |
| 5 | TiO2 | 30 |
| 6 | SiO2 | 75 |
| 7 | TiO2 | 50 |
| 8 | SiO2 | 30 |
| 9 | TiO2 | 55 |
| 10 | SiO2 | 100 |
| 11 | TiO2 | 65 |
| 12 | SiO2 | 100 |
| 13 | TiO2 | 55 |
| 14 | SiO2 | 90 |
| 15 | TiO2 | 80 |
| 16 | SiO2 | 70 |
| 17 | TiO2 | 45 |
| 18 | SiO2 | 105 |

Referring to FIG. 9, a first layer 310 may include a titanium oxide layer having a thickness of about 35 nm. A second layer 315 may include a silicon oxide layer having a thickness of about 85 nm. A third layer 320 may include a titanium oxide layer having a thickness of about 50 nm. A fourth layer 325 may include a silicon oxide layer having a thickness of about 70 nm. A fifth layer 330 may include a titanium oxide layer having a thickness of about 30 nm. A sixth layer 335 may include a silicon oxide layer having a thickness of about 75 nm. A seventh layer 340 may include a titanium oxide layer having a thickness of about 50 nm. An eighteenth layer 395 may include a silicon oxide layer having a thickness of about 105 nm.

In example embodiments, the optical sensor may be formed by a CVD process, an ALD process, or the like, using silicon oxide and titanium oxide in a single chamber.

The stack type single band filter including the silicon oxide layer and the titanium oxide layer sequentially stacked may allow the light having the wavelength of no less than about 800 nm to pass through.

FIG. 10 is a cross-sectional view of an optical sensor according to example embodiments.

Referring to FIG. 10, the optical sensor may include a RGB-Z chip on a semiconductor substrate having a color pixel array photodiode region 400 and a distance pixel array region 410. An infrared light cut filter 420 may be formed on the color pixel array photodiode region 400. The infrared light cut filter 420 may allow a visible light to pass through. In contrast, the infrared light cut filter 420 may block a near infrared light. In example embodiments, the infrared light cut filter 420 may include a polymer. A long wave pass filter 430 may be formed on the distance pixel array region 410. The long wave pass filter 430 may block the visible light. In contrast, the long wave pass filter 430 may allow the infrared light to pass through. In example embodiments, the long wave pass filter 430 may include a polymer.

An RGB filter 440 may be arranged on the infrared light cut filter 420. The RGB filter 440 may allow the visible light to pass through. In contrast, the RGB filter 440 may block the infrared light.

In example embodiments, the optical sensor including the infrared light cut filter 420 and the long wave pass filter 430 may be formed by a CVD process, an ALD process, or the like, using silicon oxide and titanium oxide in a single chamber.

Light may be incident on a lens module. The RGB filter 440 may allow the visible light to pass through. In contrast, the RGB filter 440 may block the infrared light. The visible light may be incident on the infrared light cut filter 420. The infrared light cut filter 420 may allow the visible light to pass through. Thus, only the visible light may be incident on the color pixel array photodiode region 400.

Further, the light may be incident on the long wave pass filter 430. The long wave pass filter 430 may allow the infrared light to pass through. In contrast, the long wave pass 430 may block the visible light. Thus, only the infrared light may be incident on the distance pixel region 410.

FIG. 11 is a plan view of an optical sensor including an RGB-Z chip according to example embodiments.

Referring to FIG. 11, an RGB-Z chip may include a CMOS image sensor (CIS) and a distance sensor. The CIS and the distance sensor may be built on a single substrate. The RGB-Z chip may have an RGB filter region and a near infrared light filter region. The RGB filter region may output image information. The near infrared light filter region may output distance information.

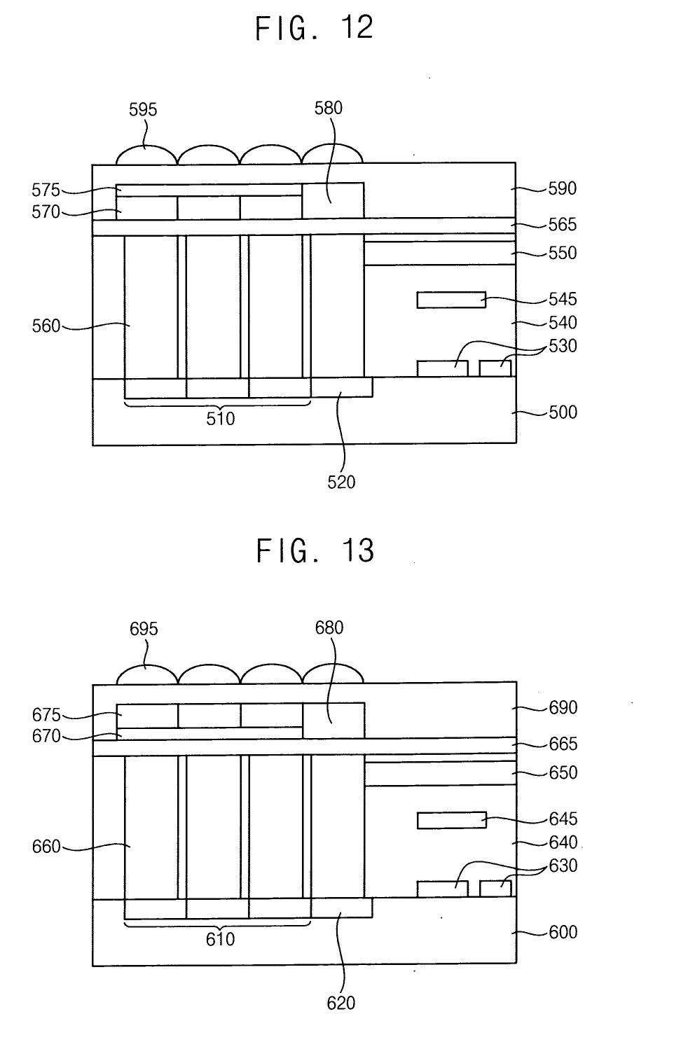

FIG. 12 is a cross-sectional view of a semiconductor device including an optical sensor of FIG. 11, according to example embodiments.

Referring to FIG. 12, the semiconductor device may include a semiconductor substrate 500, an RGB photodiode 510, a Z-diode 520 and peripheral circuits 530. The RGB photodiode 510 may be portion of a color pixel array and may detect the image information. The Z-diode 520 may be portion of a distance detecting array and may detect the distance information.

The peripheral circuits 530 and an insulating interlayer 540 may be formed on the semiconductor substrate 500. A metal wiring 545 may be formed in/on the insulating interlayer 540. A light-inducing member 560 may be formed on the RGB photodiode 510 and the Z-diode 520. In example embodiments, the light-inducing member 560 may include a resin layer.

A planarization layer 565 may be formed on the light-inducing member 560. An RGB filter 570 may be formed over the RGB photodiode 510. A near infrared light filter 580 may be formed over the Z-diode 520. An infrared light cut filter 575 may be formed on the RGB filter 570.

A protection layer 590 may be formed on the infrared light cut filter 575 and the near infrared light filter 580. A lens 595 may be formed on the protection layer 590.

FIG. 13 is a cross-sectional view of a semiconductor device including an optical sensor of FIG. 11 according to example embodiments.

Referring to FIG. 13, the semiconductor device may include a semiconductor substrate 600, an RGB photodiode 610, a Z-diode 620 and peripheral circuits 630. The RGB photodiode 610 may be a portion of a color pixel array and may detect the image information. The Z-diode 620 may be a portion of a distance pixel array and may detect the distance information.

The peripheral circuits 630 and an insulating interlayer 640 may be formed on the semiconductor substrate 600. A metal wiring 645 may be formed in the insulating interlayer 640. A light-inducing member 660 may be formed on the RGB photodiode 610 and the Z-diode 620. In example embodiments, the light-inducing member 660 may include a resin layer.

A planarization layer 665 may be formed on the light-inducing member 660. An infrared light cut filter 670 may be formed over the RGB photodiode 610. A near infrared light filter 680 may be formed over the Z-diode 620. An RGB filter 675 may be formed on the infrared light filter 670.

A protection layer 690 may be formed on the RGB filter 675 and the near infrared light filter 680. A lens 695 may be formed on the protection layer 690.

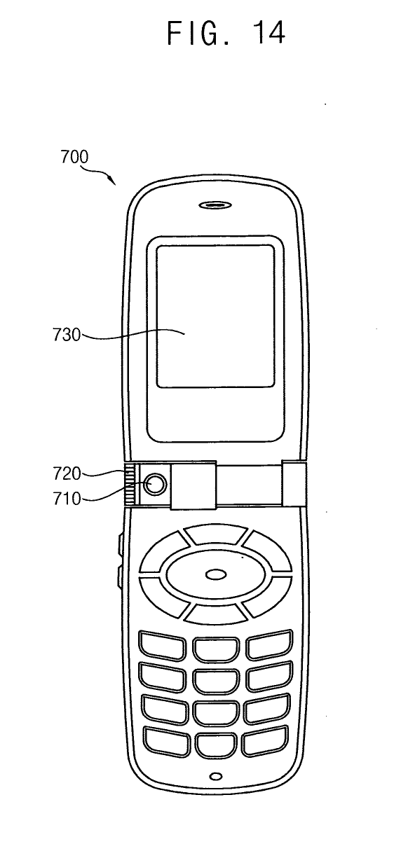

FIG. 14 is a front view illustrating a cellular phone including an optical sensor according to example embodiments.

Referring to FIG. 14, the cellular phone 700 may include a camera lens module 710, a three-dimensional optical system 720 and a display 730. The three-dimensional optical system 720 may include the optical sensor according to example embodiments. Thus, any further illustrations and explanation with respect to the three-dimensional optical system 720 are omitted herein for brevity. The display 730 may display image information and distance information output from the three-dimensional optical system 720. Thus, the cellular phone 700 may function as a navigator according to example embodiments.

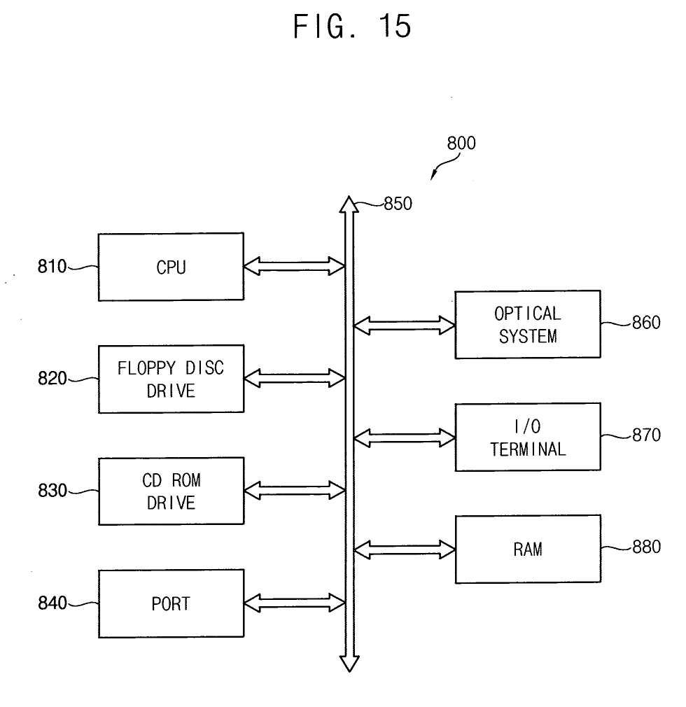

FIG. 15 is a block diagram illustrating a system including the optical sensor, according to example embodiments.

Referring to FIG. 15, a system 800 may include a three-dimensional optical system 860 that may include an optical sensor according to example embodiments. The system 800 may process signals including image information and distance information output from the three-dimensional optical system 860.

The system 800 may include input/output terminals 870 and a central processing unit (CPU) 810. The CPU 810 may communicate with the input/output terminals 880 through a bus 850. Further, the CPU 810 may be connected with a floppy disc drive 820 and/or a CD-ROM drive 830, a port 840 and an RAM 880 through the bus 850 to output data from the three-dimensional optical system 860. Thus, when the system 800 may be built in a car, a driver may be provided with image and distance data in real time.

The port 840 may be coupled to a video card, a sound card, a memory card, a USB element, or the like. Alternatively, the port 840 may communicate with other systems.

The three-dimensional optical system 860 may be integrated together with a CPU, a DSP, a microprocessor, a memory, or the like.

According to these example embodiments, the semiconductor device may provide image information and distance information. Thus, the semiconductor device may be used in space-air industry, military industry, automobile industry, information and communication industry, or the like.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A semiconductor device comprising:
a color pixel array on a substrate;
a distance pixel array on the substrate;
a light-inducing member on the color pixel array and the distance pixel array;
an infrared light cut filter on the light-inducing member and configured to block infrared light;
a near infrared light filter on the light-inducing member and configured to allow near infrared light to pass; and
an RGB filter on the light-inducing member and configured to allow visible light to pass.

2. The semiconductor device of claim 1, wherein the infrared light cut filter is on the color pixel array.

3. The semiconductor device of claim 1, wherein the near infrared light filter is on the distance pixel array.

4. The semiconductor device of claim 1, wherein the RGB filter is on the infrared light cut filter.

5. The semiconductor device of claim 1, wherein the infrared light cut filter is on the RGB filter.

6. The semiconductor device of claim 1, wherein the visible light has a wavelength of about 400 nm to about 700 nm.

7. The semiconductor device of claim 1, further comprising a plurality of lenses on the infrared light cut filter and the near infrared light filter.

8. The semiconductor device of claim 1, wherein the infrared light cut filter and the near infrared light filter a silicon oxide layer and a titanium oxide layer sequentially stacked, the silicon oxide layer and the titanium oxide layer having different thicknesses.

9. The semiconductor device of claim 1, wherein the RGB filter and the near infrared light filter include a pigment or a dye.

10. An optical sensor, comprising:
a color pixel array on a substrate;
a distance pixel array on the substrate; and
a RGB filter on the color pixel array and configured to allow visible light to pass.

11. The optical sensor of claim 10, further comprising:
a near infrared light filter on the distance array and configured to allow near infrared light to pass; and
a stack type filter on the RGB filter and configured to allow visible light to pass.

12. The optical sensor of claim 10, further comprising:
an infrared light cut filter on the color pixel array and configured to allow visible light to pass; and
a long wave pass filter on the distance pixel array and configured to allow infrared light to pass.

13-22. (canceled)
